(19) United States
(12) Patent Application Publication
(10) Pub. No.: US 2018/0190212 A1
(43) Pub. Date: Jul. 5, 2018

(54) GATE SCANNING SIGNAL GENERATING CIRCUIT AND GATE DRIVING METHOD

(71) Applicants: BOE TECHNOLOGY GROUP CO., LTD., Beijing (CN); BEIJING BOE DISPLAY TECHNOLOGY CO., LTD., Beijing (CN)

(72) Inventor: Lei Liu, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/533,788

(22) PCT Filed: Dec. 5, 2016
(86) PCT No.: PCT/CN2016/108561

§ 371 Date: Jun. 7, 2017

(30) Foreign Application Priority Data
Jun. 22, 2016 (CN) 201610460824.6

(51) Int. Cl. G09G 3/36

(52) U.S. Cl. CPC G09G 3/36; G09G 2310/0291; G09G 2310/0267

(57) ABSTRACT

The present application discloses a gate scanning signal generating circuit for providing a gate scanning signal to a thin film transistor coupled to a gate line of a display panel. The gate scanning signal generating circuit includes a first sub-circuit configured to receive M numbers of gate high voltage signals, the first sub-circuit having a first output terminal configured to output the M numbers of gate high voltage signals consecutively for turning on the thin film transistor coupled to the gate line; and a second sub-circuit configured to receive N numbers of gate low voltage signal, the second sub-circuit having a second output terminal configured to output the N numbers of gate low voltage signals consecutively for turning off the thin film transistor coupled to the gate line.

### CROSS-REFERENCE TO RELATED APPLICATION

This application claims priority to Chinese Patent Application No. 201610460824.6, filed Jun. 22, 2016, the contents of which are incorporated by reference in the entirety.

### TECHNICAL FIELD

The present invention relates to display technology, more particularly, to a gate scanning signal generating circuit and a gate driving method.

### BACKGROUND

A thin film transistor (TFT)-driven display apparatus uses a thin film transistor for driving image display. A thin film transistor-driven display apparatus typically includes a plurality of subpixel, each of which contains a thin film transistor, and a plurality of gate lines and a plurality of data lines for driving image display of the subpixels. When a voltage applied to the gate electrode of the thin film transistor exceeds a threshold voltage value, the channel (i.e., the active layer) is turned on, connecting the source electrode and the drain electrode. The signal in the data line is transmitted from the source electrode to the drain electrode, controlling light emission in the subpixel. The thin film transistor-driven display apparatus further includes a gate driving circuit for outputting gate scanning signals to the plurality of gate lines.

### SUMMARY

In one aspect, the present disclosure provides a gate scanning signal generating circuit for providing a gate scanning signal to a thin film transistor coupled to a gate line of a display panel, comprising a first sub-circuit configured to receive M numbers of gate high voltage signals, the first sub-circuit having a first output terminal configured to output the M numbers of gate high voltage signals consecutively for turning on the thin film transistor coupled to the gate line; and a second sub-circuit configured to receive N numbers of gate low voltage signal, the second sub-circuit having a second output terminal configured to output the N numbers of gate low voltage signals consecutively for turning off the thin film transistor coupled to the gate line; wherein M≥1, N≥1, M>1 when N=1, and N>1 when M=1; each of the M numbers of gate high voltage signals has a voltage level higher than that of a threshold voltage of a thin film transistor of the display panel; each of the M numbers of gate high voltage signals having a different voltage level when M>1; and each of the N numbers of gate low voltage signals has a voltage level lower than that of the threshold voltage of the thin film transistor of the display panel; each of the N numbers of gate low voltage signals having a different voltage level when N>1.

Optionally, the first sub-circuit further comprises a first input terminal for sequentially receiving at least one high voltage control signal; the at least one high voltage control signal is configured to drive the gate scanning signal to the M numbers of gate high voltage signals consecutively; the second sub-circuit further comprises a second input terminal for receiving at least one low voltage control signal; and the at least one low voltage control signal is configured to drive the gate scanning signal to the N numbers of gate low voltage signals consecutively.

Optionally, at least one of the M numbers of gate high voltage signals has a voltage level higher than approximately 25 V when M>1; and at least one of the N numbers of gate low voltage signals has a voltage level lower than approximately −7 V when N>1.

Optionally, the gate scanning signal generating circuit further comprises a third sub-circuit configured to output the gate scanning signal to the thin film transistor coupled to the gate line; the third sub-circuit comprises a third input terminal for receiving a gate control signal and a third output terminal for outputting the gate scanning signal; the third sub-circuit is configured to output the M numbers of gate high voltage signals as the gate scanning signal consecutively when the gate control signal is a first gate control signal; and output the N numbers of gate low voltage signals as the gate scanning signal consecutively when the gate control signal is a second gate control signal.

Optionally, The gate scanning signal generating circuit of claim 4, wherein: the third sub-circuit comprises a first switching transistor and a second switching transistor; a gate terminal of the first switching transistor and a gate terminal of the second switching transistor are configured to receive the gate control signal; a first terminal of the first switching transistor is coupled to the first output terminal, configured to receive the M numbers of gate high voltage signals consecutively; a first terminal of the second switching transistor is coupled to the second output terminal, configured to receive the N numbers of gate low voltage signals consecutively; a second terminal of the first switching transistor is coupled to the third output terminal, configured to output the M numbers of gate high voltage signals as the gate scanning signal consecutively when the gate control signal is a first gate control signal; and a second terminal of the second switching transistor is coupled to the third output terminal, configured to output the N numbers of gate low voltage signals as the gate scanning signal consecutively when the gate control signal is a second gate control signal.

Optionally, the first sub-circuit further comprises a third switching transistor and a fourth switching transistor; a gate terminal of the third switching transistor and a gate terminal of the fourth switching transistor are configured to sequentially receive the at least one high voltage control signal; a first terminal of the third switching transistor is configured to receive a first gate high voltage signal; a first terminal of the fourth switching transistor is configured to receive a second gate high voltage signal; the first gate high voltage signal having a voltage level higher than that of the second gate high voltage signal; and a second terminal of the third switching transistor and a second terminal of the fourth switching transistor are coupled to the first output terminal, respectively, configured to output the first gate high voltage signal and the second gate high voltage signal consecutively.

Optionally, the third switching transistor is configured to turn on and the fourth switching transistor is configured to turn off when the at least one high voltage control signal is a first high voltage control signal; the second terminal of the third switching transistor is configured to output the first gate high voltage signal to the first output terminal; the fourth switching transistor is configured to turn on and the third switching transistor is configured to turn off when the at least one high voltage control signal is a second high voltage control signal; the second terminal of the fourth switching transistor is configured to output the second gate high voltage signal to the first output terminal; and the second high voltage control signal is different from the first high voltage control signal.

Optionally, the second sub-circuit further comprises a fifth switching transistor and a sixth switching transistor; a gate terminal of the fifth switching transistor and a gate terminal of the sixth switching transistor are configured to receive the at least one low voltage control signal; a first terminal of the fifth switching transistor is configured to receive a first gate low voltage signal; a first terminal of the sixth switching transistor is configured to receive a second gate low voltage signal; the first gate low voltage signal having a voltage level lower than that of the second gate low voltage signal; and a second terminal of the fifth switching transistor and a second terminal of the sixth switching transistor are coupled to the second output terminal, respectively, configured to output the first gate low voltage signal and the second gate low voltage signal consecutively.

Optionally, the fifth switching transistor is configured to turn on and the sixth switching transistor is configured to turn off when the at least one low voltage control signal is a first low voltage control signal; the second terminal of the fifth switching transistor is configured to output the first gate low voltage signal to the second output terminal; the sixth switching transistor is configured to turn on and the fifth switching transistor is configured to turn off when the at least one low voltage control signal is a second low voltage control signal; the second terminal of the sixth switching transistor is configured to output the second gate low voltage signal to the second output terminal; and the second low voltage control signal is different from the first low voltage control signal.

In another aspect, the present disclosure provides a display apparatus comprising a gate scanning signal generating circuit described herein.

In another aspect, the present disclosure provides a gate driving method, comprising generating a gate scanning signal; and providing the gate scanning signal to a gate line of a display panel; wherein generating the gate scanning signal comprises generating M numbers of gate high voltage signals consecutively for turning on a thin film transistor coupled to the gate line followed by N numbers of gate low voltage signal consecutively for turning off the thin film transistor coupled to the gate line; M≥1, N≥1, M>1 when N=1, and N>1 when M=1; each of the M numbers of gate high voltage signals has a voltage level higher than that of a threshold voltage of a thin film transistor of the display panel; each of the M numbers of gate high voltage signals having a different voltage level when M>1; and each of the N numbers of gate low voltage signals has a voltage level lower than that of the threshold voltage of the thin film transistor of the display panel; each of the N numbers of gate low voltage signals having a different voltage level when N>1.

Optionally, the gate driving method further comprises sequentially generating at least one high voltage control signal to drive the gate scanning signal to the M numbers of gate high voltage signals consecutively; and generating at least one low voltage control signal to drive the gate scanning signal to the N numbers of gate low voltage signals consecutively.

Optionally, the gate driving method further comprises receiving a gate control signal; outputting the M numbers of gate high voltage signals as the gate scanning signal consecutively when the gate control signal is a first gate control signal; and outputting the N numbers of gate low voltage signals as the gate scanning signal consecutively when the gate control signal is a second gate control signal.

Optionally, at least one of the M numbers of gate high voltage signals has a voltage level higher than approximately 25 V when M>1; and at least one of the N numbers of gate low voltage signals has a voltage level lower than approximately −7 V when N>1.

Optionally, generating the gate scanning signal comprises generating a first gate high voltage signal and a second gate high voltage signal consecutively; the first gate high voltage signal has a voltage level higher than that of the second gate high voltage signal; and the method further comprises generating a first high voltage control signal to drive the gate scanning signal to the first gate high voltage signal sequentially followed by generating a second high voltage control signal to drive the gate scanning signal to the second gate high voltage signal.

Optionally, the first gate high voltage signal has a voltage level higher than approximately 25 V.

Optionally, generating the gate scanning signal comprises generating a first gate low voltage signal and a second gate low voltage signal consecutively; and the first gate low voltage signal has a voltage level lower than that of the second gate low voltage signal; the method further comprises generating a first low voltage control signal to drive the gate scanning signal to the first gate low voltage signal sequentially followed by generating a second low voltage control signal to drive the gate scanning signal to the second gate low voltage signal.

Optionally, the first gate low voltage signal has a voltage level lower than approximately −7 V.

Optionally, the generating gate scanning signal comprises generating a first gate high voltage signal, a second gate high voltage signal, a first gate low voltage signal, and a second gate low voltage signal consecutively; the first gate high voltage signal has a voltage level higher than that of the second gate high voltage signal; and the first gate low voltage signal has a voltage level lower than that of the second gate low voltage signal; the method further comprises generating a first high voltage control signal to drive the gate scanning signal to the first gate high voltage signal sequentially followed by generating a second high voltage control signal to drive the gate scanning signal to the second gate high voltage signal; and generating a first low voltage control signal to drive the gate scanning signal to the first gate low voltage signal sequentially followed by generating a second low voltage control signal to drive the gate scanning signal to the second gate low voltage signal.

Optionally, the first gate high voltage signal has a voltage level higher than approximately 25 V; and the first gate low voltage signal has a voltage level lower than approximately −7 V.

### BRIEF DESCRIPTION OF THE FIGURES

The following drawings are merely examples for illustrative purposes according to various disclosed embodiments and are not intended to limit the scope of the present invention.

FIG. 1 is a diagram illustrating the structure of a conventional gate scanning signal generating circuit.

FIG. 2 is a diagram illustrating a gate driving method in some embodiments according to the present disclosure.

FIG. 3 is a block diagram illustrating the structure of a gate scanning signal generating circuit in some embodiments according to the present disclosure.

FIG. 4 is a circuit diagram of a gate scanning signal generating circuit in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

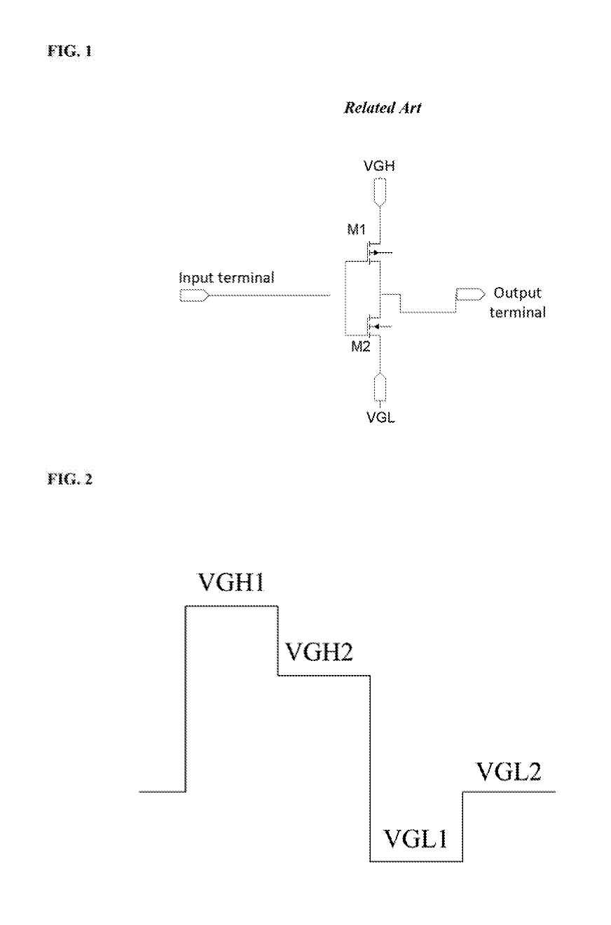

FIG. 1 is a diagram illustrating the structure of a conventional gate scanning signal generating circuit. Referring to FIG. 1, the conventional gate scanning signal generating circuit is used for providing a gate scanning signal to a plurality of thin film transistors. The gate scanning signal is provided to a plurality rows of gate lines row-by-row, each row of the plurality of gate lines is coupled to a plurality of thin film transistors in a row of sub-pixels. Typically, the conventional gate scanning signal generating circuit is disposed between a VGH terminal receiving a high voltage signal VGH and a VGL terminal receiving a low voltage signal VGL. As shown in FIG. 1, the conventional gate scanning signal generating circuit includes an input terminal for receiving a control signal and an output terminal for outputting a gate scanning signal. The conventional gate scanning signal generating circuit includes a p-type transistor M1 and an n-type transistor M2.

When the control signal is a high voltage signal, the p-type transistor M1 is turned on, while the n-type transistor M2 is turned off. The high voltage signal VGH is outputted as the gate scanning signal. When the control signal is a low voltage signal, the p-type transistor M1 is turned off, while the n-type transistor M2 is turned on. The low voltage signal VGL is outputted as the gate scanning signal.

Due to a relatively long signal transmitting distance over the gate line and a relatively short charging duration, the charging rate in a display panel having the conventional gate scanning signal generating circuit is typically low. The gate lines have certain resistance and parasitic capacitance, which result in resistance-capacitance delay (RC delay). To avoid double line defect, the gate scanning signal for the next gate line is not outputted until the gate scanning signal for the current gate line reaches a level lower that the turn-off voltage of the thin film transistor, resulting in a gate output enable (GOE) delay. This leads to a low charging rate in the display panel.

Accordingly, the present invention provides, inter alia, a gate scanning signal generating circuit and a gate driving method that substantially obviate one or more of the problems due to limitations and disadvantages of the related art. In one aspect, the present disclosure provides a gate scanning signal generating circuit for providing a gate scanning signal to a thin film transistor coupled to a gate line. In some embodiments, the gate scanning signal generating circuit includes a first sub-circuit configured to receive M numbers of gate high voltage signals, the first sub-circuit having a first output terminal configured to output the M numbers of gate high voltage signals consecutively for turning on the thin film transistor coupled to the gate line; and a second sub-circuit configured to receive N numbers of gate low voltage signal, the second sub-circuit having a second output terminal configured to output the N numbers of gate low voltage signals consecutively for turning off the thin film transistor coupled to the gate line; M≥1, N≥1, M>1 when N=1, and N>1 when M=1. Each of the M numbers of gate high voltage signals has a voltage level higher than that of a threshold voltage of a thin film transistor of the display panel; each of the M numbers of gate high voltage signals having a different voltage level when M>1. Each of the N numbers of gate low voltage signals has a voltage level lower than that of the threshold voltage of the thin film transistor of the display panel; each of the N numbers of gate low voltage signals having a different voltage level when N>1.

For example, in some embodiments, the gate scanning signal generated by the present gate scanning signal generating circuit includes a first gate high voltage signal and a second gate high voltage signal. When the gate scanning voltage is switched from a gate low voltage signal to a gate high voltage signal, it was first switched to a first gate high voltage signal having a higher voltage level than a normal gate high voltage signal, followed by switching to a second gate high voltage signal which is a normal gate high voltage signal. By having this design, the gate scanning voltage can reach a voltage level for turning on the thin film transistor in a shorter duration, thereby increasing the charging duration and charging rate of the display panel. In another example, the gate scanning signal generated by the present gate scanning signal generating circuit includes a first gate low voltage signal and a second gate low voltage signal. When the gate scanning voltage is switched from a gate high voltage signal to a gate low voltage signal, it was first switched to a first gate low voltage signal having a lower voltage level than a normal gate low voltage signal, followed by switching to a second gate low voltage signal which is a normal gate low voltage signal. By having this design, the gate scanning voltage can reach a voltage level for turning off the thin film transistor in a shorter duration, thereby increasing the charging duration and charging rate of the display panel.

For example, a voltage level required for turning on a thin film transistor is approximately 10 V or higher, and a voltage level required for turning off a thin film transistor is approximately −3 V or lower. A normal gate high voltage signal has a voltage level of approximately 25 V, and a normal gate low voltage signal has a voltage level of approximately −7 V. A typical RC delay is approximately 1 μs, i.e., the duration for the gate scanning voltage to increase from −7 V to 25 V is approximately 1 μs, and the duration for the gate scanning voltage to increase from −7 V to 10 V (for turning on the thin film transistor) is approximately 0.7 μs. However, if the gate scanning voltage is to be increased from −7 V to 35 V, the RC delay is approximately 1 μs, then the duration for the gate scanning voltage to increase from −7 V to 10 V (for turning on the thin film transistor) is less than 0.7 μs (e.g., 0.3 μs). The charging time and charging rate are enhanced by the present design.

In some embodiments, the first sub-circuit further includes a first input terminal for sequentially receiving at least one high voltage control signal. The at least one high voltage control signal is configured to drive the gate scanning signal to the M numbers of gate high voltage signals consecutively. The second sub-circuit further includes a second input terminal for receiving at least one low voltage control signal. The at least one low voltage control signal is configured to drive the gate scanning signal to the N numbers of gate low voltage signals consecutively.

Optionally, at least one of the M numbers of gate high voltage signals has a voltage level higher than approximately 25 V when M>1. Optionally, at least one of the N numbers of gate low voltage signals has a voltage level lower than approximately −7 V when N>1.

In some embodiments, the gate scanning signal generating circuit of further includes a third sub-circuit configured to output the gate scanning signal to the thin film transistor coupled to the gate line. The third sub-circuit includes a third input terminal for receiving a gate control signal and a third output terminal for outputting the gate scanning signal. The third sub-circuit is configured to output the M numbers of gate high voltage signals as the gate scanning signal consecutively when the gate control signal is a first gate control signal; and output the N numbers of gate low voltage signals as the gate scanning signal consecutively when the gate control signal is a second gate control signal.

Optionally, the third sub-circuit includes a first switching transistor having a gate terminal, a first terminal, and a second terminal; and a second switching transistor having a gate terminal, a first terminal, and a second terminal. The gate terminals of the first switching transistor and the second switching transistor are configured to receive the gate control signal. The first terminal of the first switching transistor is coupled to the first output terminal, configured to receive the M numbers of gate high voltage signals consecutively. The first terminal of the second switching transistor is coupled to the second output terminal, configured to receive the N numbers of gate low voltage signals consecutively. The second terminal of the first switching transistor is coupled to the third output terminal, configured to output the M numbers of gate high voltage signals as the gate scanning signal consecutively when the gate control signal is a first gate control signal. The second terminal of the second switching transistor is coupled to the third output terminal, configured to output the N numbers of gate low voltage signals as the gate scanning signal consecutively when the gate control signal is a second gate control signal.

In some embodiments, the first sub-circuit further includes a third switching transistor having a gate terminal, a first terminal, and a second terminal; and a fourth switching transistor having a gate terminal, a first terminal, and a second terminal. The gate terminal of the third switching transistor and the gate terminal of the fourth switching transistor are configured to sequentially receive the at least one high voltage control signal. The first terminal of the third switching transistor is configured to receive a first gate high voltage signal. The first terminal of the fourth switching transistor is configured to receive a second gate high voltage signal; the first gate high voltage signal having a voltage level higher than that of the second gate high voltage signal. The second terminal of the third switching transistor and the second terminal of the fourth switching transistor are coupled to the first output terminal, respectively, configured to output the first gate high voltage signal and the second gate high voltage signal consecutively.

Optionally, the third switching transistor is turned on and the fourth switching transistor is configured to be turned off when the at least one high voltage control signal is a first high voltage control signal, and the second terminal of the third switching transistor is configured to output the first gate high voltage signal to the first output terminal. Optionally, the fourth switching transistor is turned on and the third switching transistor is configured to be turned off when the at least one high voltage control signal is a second high voltage control signal, and the second terminal of the fourth switching transistor is configured to output the second gate high voltage signal to the first output terminal. The second high voltage control signal is different from the first high voltage control signal.

In some embodiments, the second sub-circuit further includes a fifth switching transistor having a gate terminal, a first terminal, and a second terminal; and a sixth switching transistor having a gate terminal, a first terminal, and a second terminal. The gate terminal of the fifth switching transistor and the gate terminal of the sixth switching transistor are configured to receive the at least one low voltage control signal. The first terminal of the fifth switching transistor is configured to receive a first gate low voltage signal. The first terminal of the sixth switching transistor is configured to receive a second gate low voltage signal; the first gate low voltage signal having a voltage level lower than that of the second gate low voltage signal. The second terminal of the fifth switching transistor and the second terminal of the sixth switching transistor are coupled to the second output terminal, respectively, configured to output the first gate low voltage signal and the second gate low voltage signal consecutively.

Optionally, the fifth switching transistor is turned on and the sixth switching transistor is configured to be turned off when the at least one low voltage control signal is a first low voltage control signal, and the second terminal of the fifth switching transistor is configured to output the first gate low voltage signal to the second output terminal. Optionally, the sixth switching transistor is turned on and the fifth switching transistor is configured to be turned off when the at least one low voltage control signal is a second low voltage control signal, and the second terminal of the sixth switching transistor is configured to output the second gate low voltage signal to the second output terminal. The second low voltage control signal is different from the first low voltage control signal.

FIG. 2 is a diagram illustrating a gate driving method in some embodiments according to the present disclosure. Referring to FIG. 2, when the gate scanning signal is switching from a gate high voltage signal to a gate low voltage signal, the gate scanning signal is first switched to a first gate low voltage signal VGL1 having a voltage level lower than a normal gate low voltage signal, then switched to a second gate low voltage signal VGL2 having a voltage level of a normal gate low voltage signal. By having this design, the gate scanning signal can reach a voltage level sufficient for turning off the thin film transistor in a shorter duration, enhancing the charging rate and charging time of the display panel. Similarly, when the gate scanning signal is switching from a gate low voltage signal to a gate high voltage signal, the gate scanning signal is first switched to a first gate high voltage signal VGH1 having a voltage level higher than a normal gate high voltage signal, then switched to a second gate high voltage signal VGH2 having a voltage level of a normal gate high voltage signal. By having this design, the gate scanning signal can reach a voltage level sufficient for turning on the thin film transistor in a shorter duration, enhancing the charging rate and charging time of the display panel.

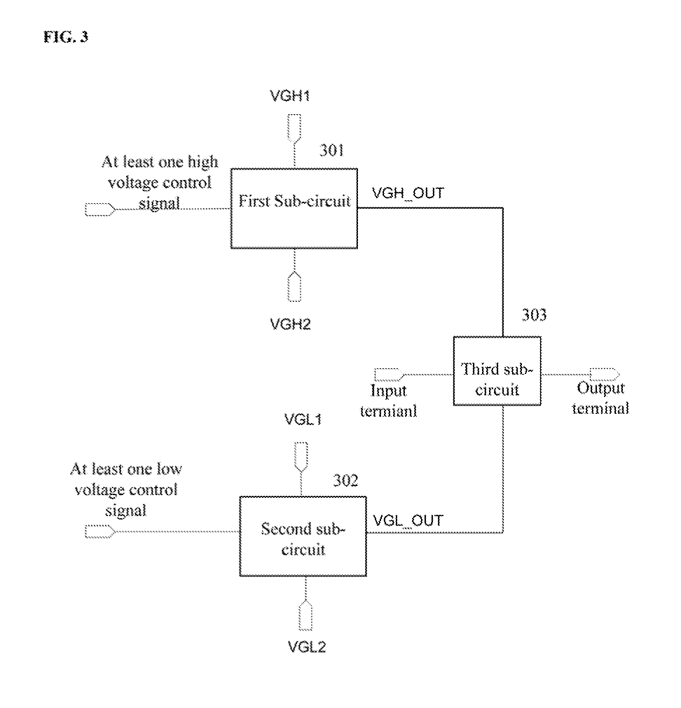

FIG. 3 is a block diagram illustrating the structure of a gate scanning signal generating circuit in some embodiments according to the present disclosure. Referring to FIG. 3, the gate scanning signal generating circuit in some embodiments includes a first sub-circuit 301, a second sub-circuit 302, and a third sub-circuit 303.

The first sub-circuit 301 is configured to receive a first gate high voltage signal VGH1 and a second gate high voltage signal VGH2. The first sub-circuit includes a first input terminal configured to sequentially receive at least one high voltage control signal, and a first output terminal VGH_OUT configured to output a gate scanning signal to the third sub-circuit 303. When the at least one high voltage control signal is a first high voltage control signal, the first output terminal VGH_OUT is configured to output the first high voltage signal VGH1 as the gate scanning signal. When the at least one high voltage control signal is a second high voltage control signal, the first output terminal VGH_OUT is configured to output the second high voltage signal VGH2 as the gate scanning signal. The first high voltage control signal is different from the second high voltage control signal. The first gate high voltage signal VGH1 has a voltage level higher than that of the second gate high voltage signal VGH2. Optionally, the second gate high voltage signal VGH2 has a voltage level of a normal gate high voltage signal, e.g., 25 V.

The second sub-circuit 302 is configured to receive a first gate low voltage signal VGL1 and a second gate low voltage signal VGL2. The second sub-circuit includes a second input terminal configured to sequentially receive at least one low voltage control signal, and a second output terminal VGL_OUT configured to output a gate scanning signal to the third sub-circuit 303. When the at least one low voltage control signal is a first low voltage control signal, the second output terminal VGL_OUT is configured to output the first low voltage signal VGL1 as the gate scanning signal to the third sub-circuit 303. When the at least one low voltage control signal is a second low voltage control signal, the second output terminal VGL_OUT is configured to output the second low voltage signal VGH2 as the gate scanning signal to the third sub-circuit 303. The first low voltage control signal is different from the second low voltage control signal. The first gate low voltage signal VGL1 has a voltage level lower than that of the second gate low voltage signal VGL2. Optionally, the second gate low voltage signal VGL2 has a voltage level of a normal gate low voltage signal, e.g., −7 V.

The third sub-circuit 303 includes a third input terminal configured to receive a gate control signal and a third output terminal configured to output a gate scanning signal transmitted from the first sub-circuit 301 or the second sub-circuit 302 to a gate line coupled to a plurality of thin film transistor in a row. The gate control signal indicates the status of a thin film transistor under control of the gate scanning signal to be in a turned-on state or in a turned-off state. When the gate control signal is a first gate control signal, the third sub-circuit 303 is configured to output a gate scanning signal transmitted from the first sub-circuit 301, for example, output the first gate high voltage signal VGH1 and the second gate high voltage signal VGH2 consecutively. When the gate control signal is a second gate control signal, the third sub-circuit 303 is configured to output a gate scanning signal transmitted from the second sub-circuit 302, for example, output the first gate low voltage signal VGL1 and the second gate low voltage signal VGL2 consecutively. The first gate control signal is different from the second gate control signal. Optionally, the first gate control signal is a high voltage signal, and the second gate control signal is a low voltage signal. Optionally, the first gate control signal is a low voltage signal, and the second gate control signal is a high voltage signal.

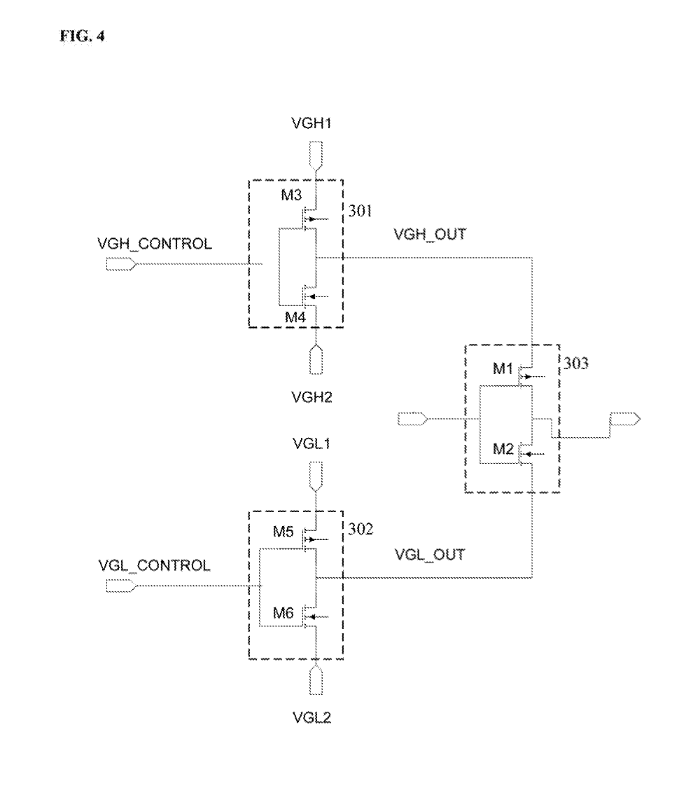

FIG. 4 is a circuit diagram of a gate scanning signal generating circuit in some embodiments according to the present disclosure. Referring to FIG. 4, the third sub-circuit 303 includes a first switching transistor M1 having a gate terminal, a first terminal, and a second terminal; and a second switching transistor M2 having a gate terminal, a first terminal, and a second terminal. The gate terminal of the first switching transistor M1 and the gate terminal of the second switching transistor M2 are configured to receive a gate control signal, e.g., a first gate control signal and a second gate control signal consecutively. The first terminal of the first switching transistor M1 is coupled to the first output terminal VGH_OUT, configured to receive the gate scanning signal transmitted from the first sub-circuit 301, for example, the first gate high voltage signal VGH1 and the second gate high voltage signal VGH2 consecutively. The first terminal of the second switching transistor M2 is coupled to the second output terminal VGL_OUT, configured to receive the gate scanning signal transmitted from the second sub-circuit 302, for example, the first gate low voltage signal VGL1 and the second gate low voltage signal VGL2 consecutively. The second terminal of the first switching transistor M1 is coupled to the third output terminal, configured to output the gate scanning signal transmitted from the first sub-circuit 301, for example, the first gate high voltage signal VGH1 and the second gate high voltage signal VGH2 consecutively when the gate control signal is a first gate control signal. The second terminal of the second switching transistor M2 is coupled to the third output terminal, configured to output the gate scanning signal transmitted from the second sub-circuit 302, for example, the first gate low voltage signal VGL1 and the second gate low voltage signal VGL2 consecutively when the gate control signal is a second gate control signal.

Referring to FIG. 4, the first sub-circuit 301 includes a third switching transistor M3 having a gate terminal, a first terminal, and a second terminal; and a fourth switching transistor M4 having a gate terminal, a first terminal, and a second terminal. The gate terminal of the third switching transistor M3 and the gate terminal of the fourth switching transistor M4 are configured to sequentially receive a high voltage control signal VGH_CONTROL (e.g., to sequentially receive a first high voltage control signal and a second high voltage control signal). The first terminal of the third switching transistor M3 is configured to receive a first gate high voltage signal VGH1. The first terminal of the fourth switching transistor M4 is configured to receive a second gate high voltage signal VGH2. The first gate high voltage signal VGH1 has a voltage level higher than that of the second gate high voltage signal VGH2. The second terminal of the third switching transistor M3 and the second terminal of the fourth switching transistor M4 are coupled to the first output terminal VGH_OUT, respectively, and configured to output the first gate high voltage signal VGH1 and the second gate high voltage signal VGH2 consecutively. The output of the gate high voltage signal VGH is controlled by the high voltage control signal VGH_CONTROL. When the high voltage control signal VGH_CONTROL is a first high voltage control signal, the third switching transistor M3 is turned on and the fourth switching transistor M4 is turned off, and the second terminal of the third switching transistor M3 is configured to output the first gate high voltage signal VGH1 to the first output terminal VGH_OUT. When the high voltage control signal VGH_CONTROL is a second high voltage control signal, the fourth switching transistor M4 is turned on and the third switching transistor M3 is turned off, and the second terminal of the fourth switching transistor M4 is configured to output the second gate high voltage signal VGH2 to the first output terminal VGH_OUT. The second high voltage control signal is different from the first high voltage control signal.

Referring to FIG. 4, the second sub-circuit 302 includes a fifth switching transistor having a gate terminal, a first terminal, and a second terminal; and a sixth switching transistor having a gate terminal, a first terminal, and a second terminal. The gate terminal of the fifth switching transistor M5 and the gate terminal of the sixth switching transistor M6 are configured to receive a low voltage control signal VGL_CONTROL (e.g., to sequentially receive a first low voltage control signal and a second low voltage control signal). The first terminal of the fifth switching transistor M5 is configured to receive a first gate low voltage signal VGL1. The first terminal of the sixth switching transistor M6 is configured to receive a second gate low voltage signal VGL2. The first gate low voltage signal VGL1 has a voltage level lower than that of the second gate low voltage signal VGL2. The second terminal of the fifth switching transistor M5 and the second terminal of the sixth switching transistor M6 are coupled to the second output terminal VGL_OUT, respectively, and configured to output the first gate low voltage signal VGL1 and the second gate low voltage signal VGL2 consecutively. The output of the gate low voltage signal VGL is controlled by the low voltage control signal VGL_CONTROL. When the low voltage control signal VGL_CONTROL is a first low voltage control signal, the fifth switching transistor M5 is turned on and the sixth switching transistor M6 is turned off, and the second terminal of the fifth switching transistor M5 is configured to output the first gate low voltage signal VGL1 to the second output terminal VGL_OUT. When the low voltage control signal VGL_CONTROL is a second low voltage control signal, the sixth switching transistor M6 is turned on and the fifth switching transistor M5 is turned off, and the second terminal of the sixth switching transistor M6 is configured to output the second gate low voltage signal VGL2 to the second output terminal VGL_OUT. The second low voltage control signal is different from the first low voltage control signal.

Referring to FIG. 4, the output of the gate scanning signal (e.g., a gate high voltage signal VGH or a gate low voltage signal VGL) is controlled by the gate control signal. When the gate control signal is a first gate control signal, the first switching transistor M1 is turned on and the second switching transistor M2 is turned off, the second terminal of the first switching transistor M1 outputs a first gate high voltage signal VGH1 or a second gate high voltage signal VGH2 to the third output terminal. When the gate control signal is a second gate control signal, the second switching transistor M2 is turned on and the first switching transistor M1 is turned off, the second terminal of the second switching transistor M2 outputs a first gate low voltage signal VGL1 or a second gate low voltage signal VGL2 to the third output terminal. A gate scanning signal having a waveform as shown in FIG. 2 is generated. By having this design, the charging time and charging rate in a display panel having the present gate scanning signal generating circuit are enhanced.

In another aspect, the present disclosure provides a gate driving method for providing a gate scanning signal to a thin film transistor coupled to a gate line. In some embodiments, the method includes generating a gate scanning signal and providing the gate scanning signal to a gate line of a display panel. In some embodiments, the step of generating the gate scanning signal includes generating M numbers of gate high voltage signals consecutively for turning on a thin film transistor coupled to the gate line followed by N numbers of gate low voltage signal consecutively for turning off the thin film transistor coupled to the gate line. Optionally, M≥1, N≥1, M>1 when N=1, and N>1 when M=1. Each of the M numbers of gate high voltage signals has a voltage level higher than that of a threshold voltage of a thin film transistor of the display panel. Each of the M numbers of gate high voltage signals has a different voltage level when M>1. Each of the N numbers of gate low voltage signals has a voltage level lower than that of the threshold voltage of the thin film transistor of the display panel. Each of the N numbers of gate low voltage signals having a different voltage level when N>1.

In some embodiments, the method further includes sequentially generating at least one high voltage control signal to drive the gate scanning signal to the M numbers of gate high voltage signals consecutively; and generating at least one low voltage control signal to drive the gate scanning signal to the N numbers of gate low voltage signals consecutively.

In some embodiments, the method further includes receiving a gate control signal; outputting the M numbers of gate high voltage signals as the gate scanning signal consecutively when the gate control signal is a first gate control signal; and outputting the N numbers of gate low voltage signals as the gate scanning signal consecutively when the gate control signal is a second gate control signal.

Optionally, at least one of the M numbers of gate high voltage signals has a voltage level higher than approximately 25 V when M>1. Optionally, at least one of the N numbers of gate low voltage signals has a voltage level lower than approximately −7 V when N>1.

Optionally, M=2. Optionally, N=2. Optionally, M and N both equal to 2.

In some embodiments, the step of generating the gate scanning signal includes generating a first gate high voltage signal and a second gate high voltage signal consecutively. The first gate high voltage signal has a voltage level higher than that of the second gate high voltage signal. Optionally, the method further includes generating a first high voltage control signal to drive the gate scanning signal to the first gate high voltage signal sequentially followed by generating a second high voltage control signal to drive the gate scanning signal to the second gate high voltage signal. Optionally, the first gate high voltage signal has a voltage level higher than approximately 25 V.

In some embodiments, the step of generating the gate scanning signal includes generating a first gate low voltage signal and a second gate low voltage signal consecutively. The first gate low voltage signal has a voltage level lower than that of the second gate low voltage signal. Optionally, the method further includes generating a first low voltage control signal to drive the gate scanning signal to the first gate low voltage signal sequentially followed by generating a second low voltage control signal to drive the gate scanning signal to the second gate low voltage signal. Optionally, the first gate low voltage signal has a voltage level lower than approximately −7 V.

In some embodiments, the step of generating the gate scanning signal includes generating a first gate high voltage signal, a second gate high voltage signal, a first gate low voltage signal, and a second gate low voltage signal consecutively. The first gate high voltage signal has a voltage level higher than that of the second gate high voltage signal. The first gate low voltage signal has a voltage level lower than that of the second gate low voltage signal. Optionally, the method further includes generating a first high voltage control signal to drive the gate scanning signal to the first gate high voltage signal sequentially followed by generating a second high voltage control signal to drive the gate scanning signal to the second gate high voltage signal, and generating a first low voltage control signal to drive the gate scanning signal to the first gate low voltage signal sequentially followed by generating a second low voltage control signal to drive the gate scanning signal to the second gate low voltage signal. Optionally, the first gate high voltage signal has a voltage level higher than approximately 25 V. Optionally, the first gate low voltage signal has a voltage level lower than approximately −7 V.

In another aspect, the present disclosure provides a display panel having a gate scanning signal generating circuit as described herein.

In another aspect, the present disclosure provides a display apparatus having a gate scanning signal generating circuit as described herein. Examples of appropriate display apparatuses include, but are not limited to, an electronic paper, a mobile phone, a tablet computer, a television, a monitor, a notebook computer, a digital album, a GPS, etc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A gate scanning signal generating circuit for providing a gate scanning signal to a thin film transistor coupled to a gate line of a display panel, comprising:
a first sub-circuit configured to receive M numbers of gate high voltage signals, the first sub-circuit having a first output terminal configured to output the M numbers of gate high voltage signals consecutively for turning on the thin film transistor coupled to the gate line; and
a second sub-circuit configured to receive N numbers of gate low voltage signal, the second sub-circuit having a second output terminal configured to output the N numbers of gate low voltage signals consecutively for turning off the thin film transistor coupled to the gate line;
wherein M≥1, N≥1, M>1 when N=1, and N>1 when M=1;
each of the M numbers of gate high voltage signals has a voltage level higher than that of a threshold voltage of a thin film transistor of the display panel; each of the M numbers of gate high voltage signals having a different voltage level when M>1; and
each of the N numbers of gate low voltage signals has a voltage level lower than that of the threshold voltage of the thin film transistor of the display panel; each of the N numbers of gate low voltage signals having a different voltage level when N>1.

2. The gate scanning signal generating circuit of claim 1, wherein the first sub-circuit further comprises a first input terminal for sequentially receiving at least one high voltage control signal;
the at least one high voltage control signal is configured to drive the gate scanning signal to the M numbers of gate high voltage signals consecutively;
the second sub-circuit further comprises a second input terminal for receiving at least one low voltage control signal; and
the at least one low voltage control signal is configured to drive the gate scanning signal to the N numbers of gate low voltage signals consecutively.

3. The gate scanning signal generating circuit of claim 1, wherein at least one of the M numbers of gate high voltage signals has a voltage level higher than approximately 25 V when M>1; and
at least one of the N numbers of gate low voltage signals has a voltage level lower than approximately −7 V when N>1.

4. The gate scanning signal generating circuit of claim 1, further comprising a third sub-circuit configured to output the gate scanning signal to the thin film transistor coupled to the gate line;
the third sub-circuit comprises a third input terminal for receiving a gate control signal and a third output terminal for outputting the gate scanning signal;
the third sub-circuit is configured to output the M numbers of gate high voltage signals as the gate scanning signal consecutively when the gate control signal is a first gate control signal; and output the N numbers of gate low voltage signals as the gate scanning signal consecutively when the gate control signal is a second gate control signal.

5. The gate scanning signal generating circuit of claim 4, wherein: the third sub-circuit comprises a first switching transistor and a second switching transistor;
a gate terminal of the first switching transistor and a gate terminal of the second switching transistor are configured to receive the gate control signal;
a first terminal of the first switching transistor is coupled to the first output terminal, configured to receive the M numbers of gate high voltage signals consecutively;
a first terminal of the second switching transistor is coupled to the second output terminal, configured to receive the N numbers of gate low voltage signals consecutively;
a second terminal of the first switching transistor is coupled to the third output terminal, configured to output the M numbers of gate high voltage signals as the gate scanning signal consecutively when the gate control signal is a first gate control signal; and
a second terminal of the second switching transistor is coupled to the third output terminal, configured to output the N numbers of gate low voltage signals as the gate scanning signal consecutively when the gate control signal is a second gate control signal.

6. The gate scanning signal generating circuit of claim 2, wherein the first sub-circuit further comprises a third switching transistor and a fourth switching transistor;
a gate terminal of the third switching transistor and a gate terminal of the fourth switching transistor are configured to sequentially receive the at least one high voltage control signal;
a first terminal of the third switching transistor is configured to receive a first gate high voltage signal;
a first terminal of the fourth switching transistor is configured to receive a second gate high voltage signal; the first gate high voltage signal having a voltage level higher than that of the second gate high voltage signal; and
a second terminal of the third switching transistor and a second terminal of the fourth switching transistor are coupled to the first output terminal, respectively, configured to output the first gate high voltage signal and the second gate high voltage signal consecutively.

7. The gate scanning signal generating circuit of claim 6, wherein
the third switching transistor is configured to turn on and the fourth switching transistor is configured to turn off when the at least one high voltage control signal is a first high voltage control signal; the second terminal of the third switching transistor is configured to output the first gate high voltage signal to the first output terminal;
the fourth switching transistor is configured to turn on and the third switching transistor is configured to turn off when the at least one high voltage control signal is a second high voltage control signal; the second terminal of the fourth switching transistor is configured to output the second gate high voltage signal to the first output terminal; and
the second high voltage control signal is different from the first high voltage control signal.

8. The gate scanning signal generating circuit of claim 2,
wherein the second sub-circuit further comprises a fifth switching transistor and a sixth switching transistor;
a gate terminal of the fifth switching transistor and a gate terminal of the sixth switching transistor are configured to receive the at least one low voltage control signal;
a first terminal of the fifth switching transistor is configured to receive a first gate low voltage signal;
a first terminal of the sixth switching transistor is configured to receive a second gate low voltage signal; the first gate low voltage signal having a voltage level lower than that of the second gate low voltage signal; and
a second terminal of the fifth switching transistor and a second terminal of the sixth switching transistor are coupled to the second output terminal, respectively, configured to output the first gate low voltage signal and the second gate low voltage signal consecutively.

9. The gate scanning signal generating circuit of claim 8, wherein
the fifth switching transistor is configured to turn on and the sixth switching transistor is configured to turn off when the at least one low voltage control signal is a first low voltage control signal; the second terminal of the fifth switching transistor is configured to output the first gate low voltage signal to the second output terminal;
the sixth switching transistor is configured to turn on and the fifth switching transistor is configured to turn off when the at least one low voltage control signal is a second low voltage control signal; the second terminal of the sixth switching transistor is configured to output the second gate low voltage signal to the second output terminal; and
the second low voltage control signal is different from the first low voltage control signal.

10. A display apparatus, comprising a gate scanning signal generating circuit of claim 1.

11. A gate driving method, comprising:
generating a gate scanning signal; and
providing the gate scanning signal to a gate line of a display panel;
wherein generating the gate scanning signal comprises generating M numbers of gate high voltage signals consecutively for turning on a thin film transistor coupled to the gate line followed by N numbers of gate low voltage signal consecutively for turning off the thin film transistor coupled to the gate line; M≥1, N≥1, M>1 when N=1, and N>1 when M=1;
each of the M numbers of gate high voltage signals has a voltage level higher than that of a threshold voltage of a thin film transistor of the display panel; each of the M numbers of gate high voltage signals having a different voltage level when M>1; and
each of the N numbers of gate low voltage signals has a voltage level lower than that of the threshold voltage of the thin film transistor of the display panel; each of the N numbers of gate low voltage signals having a different voltage level when N>1.

12. The gate driving method of claim 11, further comprising sequentially generating at least one high voltage control signal to drive the gate scanning signal to the M numbers of gate high voltage signals consecutively; and
generating at least one low voltage control signal to drive the gate scanning signal to the N numbers of gate low voltage signals consecutively.

13. The gate driving method of claim 12, further comprising receiving a gate control signal;
outputting the M numbers of gate high voltage signals as the gate scanning signal consecutively when the gate control signal is a first gate control signal; and
outputting the N numbers of gate low voltage signals as the gate scanning signal consecutively when the gate control signal is a second gate control signal.

14. The gate driving method of claim 11, wherein at least one of the M numbers of gate high voltage signals has a voltage level higher than approximately 25 V when M>1; and
at least one of the N numbers of gate low voltage signals has a voltage level lower than approximately −7 V when N>1.

15. The gate driving method of claim 11, wherein generating the gate scanning signal comprises generating a first gate high voltage signal and a second gate high voltage signal consecutively;
the first gate high voltage signal has a voltage level higher than that of the second gate high voltage signal; and
the method further comprises generating a first high voltage control signal to drive the gate scanning signal to the first gate high voltage signal sequentially followed by generating a second high voltage control signal to drive the gate scanning signal to the second gate high voltage signal.

16. The gate driving method of claim 15, wherein the first gate high voltage signal has a voltage level higher than approximately 25 V.

17. The gate driving method of claim 11, wherein generating the gate scanning signal comprises generating a first gate low voltage signal and a second gate low voltage signal consecutively; and
the first gate low voltage signal has a voltage level lower than that of the second gate low voltage signal;
the method further comprises generating a first low voltage control signal to drive the gate scanning signal to the first gate low voltage signal sequentially followed by generating a second low voltage control signal to drive the gate scanning signal to the second gate low voltage signal.

18. The gate driving method of claim 17, wherein the first gate low voltage signal has a voltage level lower than approximately −7 V.

19. The gate driving method of claim 11, wherein the generating gate scanning signal comprises generating a first gate high voltage signal, a second gate high voltage signal, a first gate low voltage signal, and a second gate low voltage signal consecutively;
the first gate high voltage signal has a voltage level higher than that of the second gate high voltage signal; and
the first gate low voltage signal has a voltage level lower than that of the second gate low voltage signal;
the method further comprises generating a first high voltage control signal to drive the gate scanning signal to the first gate high voltage signal sequentially followed by generating a second high voltage control signal to drive the gate scanning signal to the second gate high voltage signal; and
generating a first low voltage control signal to drive the gate scanning signal to the first gate low voltage signal sequentially followed by generating a second low voltage control signal to drive the gate scanning signal to the second gate low voltage signal.

20. The gate driving method of claim 19, wherein the first gate high voltage signal has a voltage level higher than approximately 25 V; and
the first gate low voltage signal has a voltage level lower than approximately −7 V.
